(19) United States
(12) Patent Application Publication
(10) Pub. No.: US 2025/0306257 A1
(43) Pub. Date: Oct. 2, 2025

(54) Optical Film and Optical Lens Including Same

(71) Applicant: 3M INNOVATIVE PROPERTIES COMPANY, St. Paul, MN (US)

(72) Inventors: John D. Le, San Jose, CA (US); Kevin T. Huseby, Oakdale, MN (US); Stephen A. Johnson, Woodbury, MN (US); Adam D. Haag, Woodbury, MN (US); Kayla A. McGrath, Cottage Grove, MN (US); Brian R. Peterson, Glenwood City, WI (US); Jacob D. Young, St. Paul, MN (US)

(21) Appl. No.: 18/863,377

(22) PCT Filed: May 3, 2023
(86) PCT No.: PCT/IB2023/054599

§ 371 Date: Nov. 6, 2024

Related U.S. Application Data
(60) Provisional application No. 63/344,093, filed on May 20, 2022.

(51) Int. Cl. G02B 5/30

(52) U.S. Cl. CPC G02B 5/305

(57) ABSTRACT

An optical film includes a polarizer including an absorbing polarizer layer: an olefin layer disposed on the polarizer; and a bonding layer disposed between, and bonding together, the olefin layer and the polarizer. For substantially normally incident light, for orthogonal first and second polarization states, and for at least one wavelength in a wavelength range of about 420 nm to about 680 nm, the polarizer substantially transmits the incident light having the first, but not the second, polarization state. The bonding, olefin and absorbing polarizer layers are coextruded and co-stretched with one another. The olefin layer can have an unstructured major surface opposite the polarizer. An optical lens includes a lens substrate and the optical film disposed on, and substantially conforming to, a major surface of the lens substrate with the olefin layer facing the lens substrate.

### SUMMARY

In some aspects, the present description provides an optical film including a polarizer including an absorbing polarizer layer: an olefin layer disposed on the polarizer; and a bonding layer disposed between, and bonding together, the olefin layer and the polarizer. For substantially normally incident light, for orthogonal first and second polarization states, and for at least one wavelength in a wavelength range of about 420 nm to about 680 nm, the polarizer substantially transmits the incident light having the first, but not the second, polarization state. The olefin layer comprises cyclic olefin copolymer, cyclic olefin polymer, or a blend thereof. The olefin layer can have an unstructured major surface opposite the polarizer. The bonding, olefin and absorbing polarizer layers are coextruded and co-stretched with one another.

In some aspects, the present description provides an optical film including a polarizer including an absorbing polarizer layer disposed on a reflective polarizer: an olefin layer disposed on the polarizer; and a bonding layer disposed between, and bonding together, the olefin layer and the polarizer. The reflective polarizer includes a plurality of alternating first and second polymeric layers numbering at least 10 in total where each of the first and second polymeric layers having an average thickness less than about 500 nm. The olefin layer comprises cyclic olefin copolymer, cyclic olefin polymer, or a blend thereof. The olefin layer can include an unstructured major surface opposite the polarizer. The absorbing polarizer layer, the reflective polarizer, or both are coextruded and co-stretched with the bonding and olefin layers.

In some aspects, the present description provides an optical film including a polarizer including an absorbing polarizer layer: an olefin layer disposed on the polarizer; and an ethylene copolymer layer disposed between, and bonding together, the olefin layer and the polarizer. For substantially normally incident light, for orthogonal first and second polarization states, and for at least one wavelength in a wavelength range of about 420 nm to about 680 nm, the polarizer substantially transmits the incident light having the first, but not the second, polarization state. The olefin layer comprises cyclic olefin copolymer, cyclic olefin polymer, or a blend thereof. The ethylene copolymer, olefin and absorbing polarizer layers are coextruded and co-stretched with one another.

In some aspects, the present description provides an optical film including a polarizer including an absorbing polarizer layer disposed on a plurality of alternating first and second polymeric layers numbering at least 10 in total where each of the first and second polymeric layers have an average thickness less than about 500 nm; and an ethylene copolymer layer disposed on the polarizer. The absorbing polarizer layer, the plurality of alternating first and second polymeric layers, or both are coextruded and co-stretched with the ethylene copolymer layer.

In some aspects, the present description provides an optical lens including a lens substrate and an optical film described herein disposed on, and substantially conforming to, a major surface of the lens substrate with the olefin layer of the optical film facing the lens substrate.

In some aspects, the present description provides a method of making an optical lens. The method includes providing an optical film. The optical film includes a polarizer including an absorbing polarizer layer: an olefin layer disposed on the polarizer; and a bonding layer disposed between, and bonding together, the olefin layer and the polarizer. For substantially normally incident light, for orthogonal first and second polarization states, and for at least one wavelength in a wavelength range of about 420 nm to about 680 nm, the polarizer substantially transmits the incident light having the first, but not the second, polarization state. The olefin layer comprises cyclic olefin copolymer, cyclic olefin polymer, or a blend thereof. Providing the optical film can include coextruding and co-stretching the olefin layer, the bonding layer and at least one layer of the polarizer. The method includes molding a lens substrate onto the optical film such that the lens substrate faces and bonds to the olefin layer. The lens substrate can comprise an olefin composition.

These and other aspects will be apparent from the following detailed description. In no event, however, should this brief summary be construed to limit the claimable subject matter.

### BRIEF DESCRIPTION OF THE DRAWINGS

FIGS. 1-8 are schematic cross-sectional views of optical films, according to some embodiments.

FIG. 9 is a schematic plot of transmission versus wavelength for light substantially normally incident on a polarizer for orthogonal first and second polarization states, according to some embodiments.

FIG. 10 is a schematic cross-sectional view of an optical lens, according to some embodiments.

FIG. 11 is a schematic illustration of a method of making an optical lens, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

An optical system can include one or more optical lens that include an optical film disposed on a lens substrate. For example, an optical system as described in U.S. Pat. No. 9,557,568 (Ouderkirk et al), for example, includes an optical lens having an optical film (e.g., a polarizer film) disposed on a lens substrate. In some embodiments, it is desired that the lens substrate be formed from an olefin such as cyclic olefin copolymer (COC) or cyclic olefin polymer (COP) due, at least in part, to the low birefringence of such materials. However, it can be difficult to achieve adequate bonding to such lens substrates with typical materials (e.g., polyesters) used in optical films. According to some embodiments, it has been found that an optical film including a polarizer can include an outer layer that bonds well to such lens substrates and an additional bonding layer that bonds the outer layer to another layer of the polarizer. It has been found, according to some embodiments, that the materials for the outer layer, the bonding layer, and the other layers of the optical film can be chosen so that the film can be formed via coextrusion and co-stretching, for example.

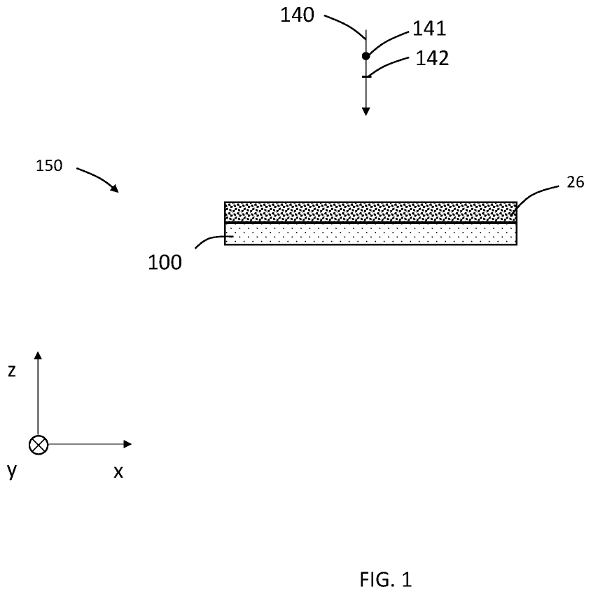

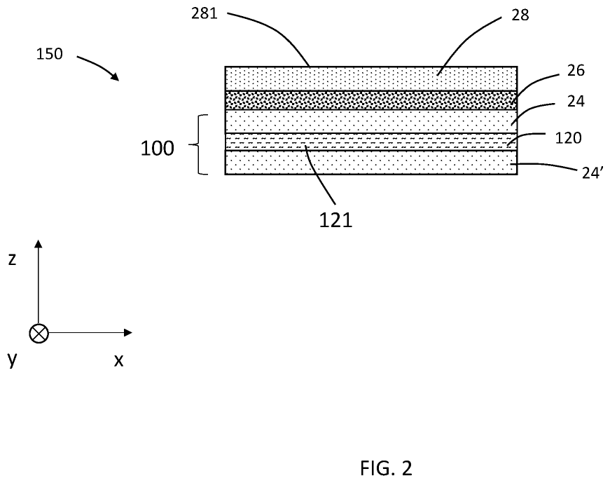

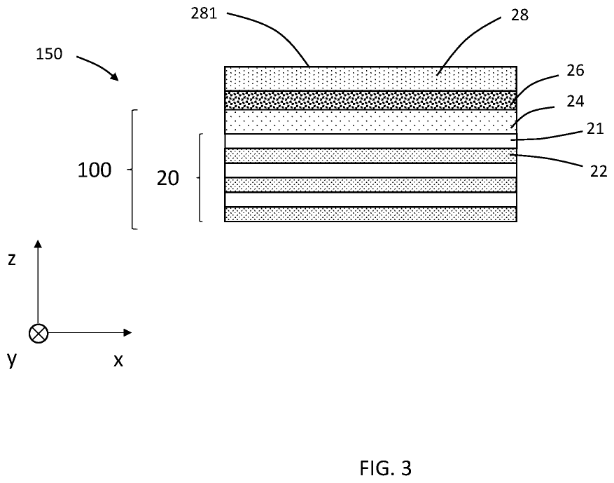

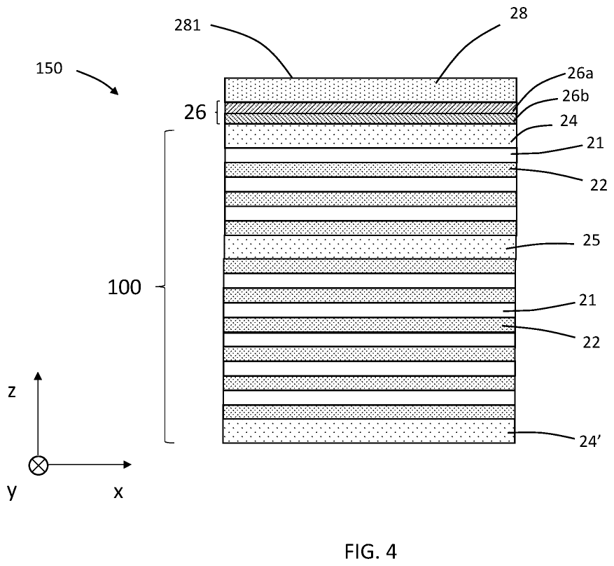

FIGS. 1-8 are schematic cross-sectional views of optical films, according to some embodiments. The optical film 150 includes a polarizer 100 which may be or include an absorbing polarizer layer. The absorbing polarizer layer can include (e.g., dichroic) dye dispersed in a polymer. In FIG. 1, the polarizer 100 is a single layer, which can be an absorbing polarizer layer, but the polarizer 100 can optionally include other layers. The optical film 150 includes a bonding layer 26, which may be an ethylene copolymer layer, and can also include an olefin layer 28 disposed on the bonding layer 26 as schematically shown in FIGS. 2-8. In FIG. 2, the polarizer 100 includes an absorbing polarizer layer 120 disposed between optional protective layers 24 and 24′. In FIG. 3, the polarizer 100 includes a plurality 20 of alternating first (21) and second (22) polymeric layers disposed on a first protective layer 24. In some embodiments, the optical film 150, includes an olefin layer 28 disposed on the first protective layer 24 opposite the plurality 20 of alternating first and second polymeric layers and includes a bonding layer 26 disposed between, and bonding together, the olefin layer 28 and the first protective layer 24. In some embodiments, at least one of the layers 21, 22, and 24 is an absorbing polarizer layer. For example, the plurality 20 of layers 21, 22 can included alternating high (e.g., 21) and low (e.g., 22) index layers, and the high index layers can include absorbing polarizer dyes as described in U.S. Pat. No. 10,928,571 (Haag et al.), for example. Other suitable multilayer films including absorbing polarizer layer(s) are described in U.S. Pat. No. 10,466,398 (Johnson et al.): U.S. Pat. No. 10,838,127 (Haag et al.); and U.S. Pat. No. 11,022,734 (Stover et al.), for example. The polarizer 100 can include more than one packet of alternating layers 21, 22 where each packet is separated by at least one layer thicker than each of the layers 21, 22, as schematically illustrated in FIG. 4.

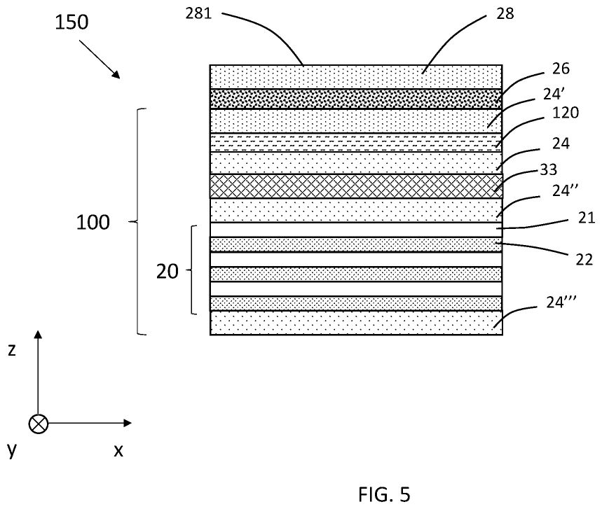

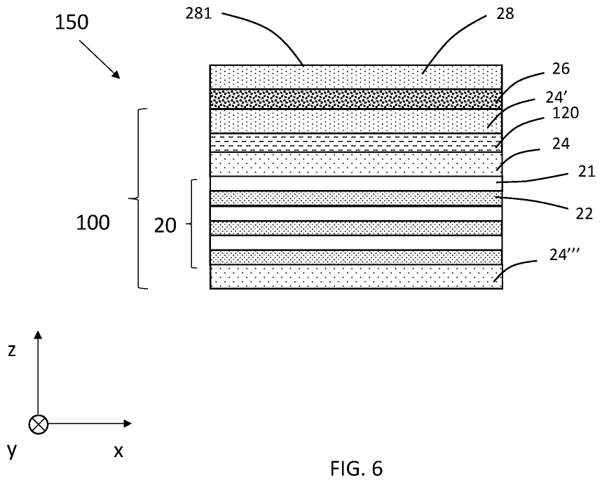

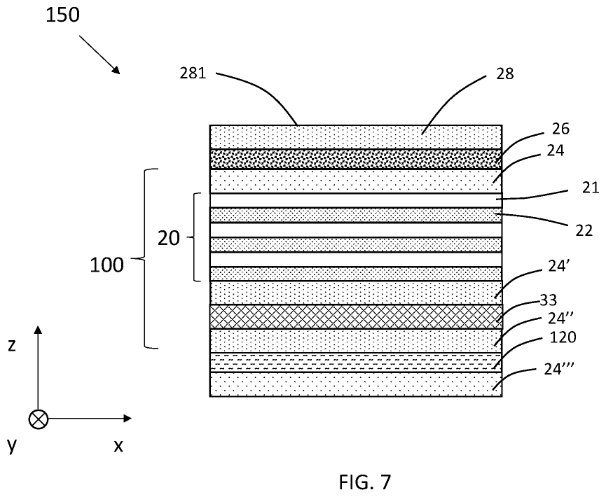

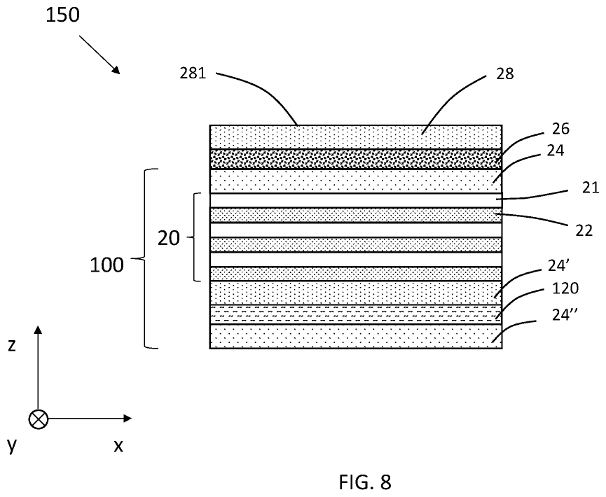

In some embodiments, the polarizer 100 includes an absorbing polarizer layer 120 and further includes a plurality 20 of alternating first and second polymeric layers 21, 22 disposed on the absorbing polarizer 120 as schematically illustrated in FIGS. 5-8, for example. The polarizer 100 can include an absorbing polarizer layer 120 bonded to the plurality 20 of alternating first and second polymeric layers 21, 22, which may be disposed between protective layers 24″, 24″, with an optional adhesive layer 33 as schematically illustrated in FIGS. 5 and 7, for example, or the absorbing polarizer layer 120 and the plurality 20 of alternating first and second polymeric layers 21, 22 can be integrally formed with one another (e.g., coextruded and co-stretched with one another) as schematically illustrated in FIGS. 6 and 8, for example. The polarizer 100 can include a reflective polarizer. For example, the plurality 20 of alternating first and second polymeric layers 21, 22 can be a reflective polarizer, or the plurality 20 of alternating first and second polymeric layers 21, 22 together with any adjacent protective layers 24, 24′ can be a reflective polarizer. In some embodiments, the polarizer 100 includes a multilayer reflective polarizer 20, or 20 with adjacent protective layers, bonded (directly or indirectly through intermediate layers) to the absorbing polarizer layer 120 with an adhesive layer 33. The absorbing polarizer layer 120 can be disposed between the multilayer reflective polarizer and the olefin layer 28 as schematically illustrated in FIG. 5 (or FIG. 6 when the adhesive layer 33 is omitted), for example, or the multilayer reflective polarizer can be disposed between the absorbing polarizer layer 120 and the olefin layer 28 as schematically illustrated in FIG. 7 (or FIG. 8 when the adhesive layer 33 is omitted), for example. In some embodiments, the bonding layer 26, the olefin layer 28 and the reflective polarizer 20 (or 20 with adjacent protective layers) are coextruded and co-stretched with one another: the reflective polarizer 20 is disposed between the absorbing polarizer layer 120 and the olefin layer 28; and an adhesive layer 33 bonds (directly or indirectly) the absorbing polarizer layer 120 to the reflective polarizer 20. In some embodiments, the olefin layer 28 and the absorbing polarizer layer 120 are coextruded and co-stretched with one another: the absorbing polarizer layer 120 is disposed between the reflective polarizer 20 and the olefin layer 28; and an adhesive layer bonds (directly or indirectly) the reflective polarizer 20 to the absorbing polarizer layer 120.

In some embodiments, each of the first and second polymeric layers 21, 22 has an average thickness of less than about 500, 400, 350, 300, 250, or 200 nm. The average thickness may be, for example, at least about 20 nm or at least about 40 nm. For example, in some embodiments, each of the first and second polymeric layers has an average thickness in a range of about 20 nm to about 500 nm or about 40 nm to about 400 nm. In some embodiments, the first protective layer 24 (and/or other protective layers) has an average thickness greater than about 750, 1000, 1500, or 2000 nm, for example. The average thickness of the first protective layer 24 can be up to about 30 micrometer or up to about 20 micrometers, for example. In some embodiments, the absorbing polarizer layer 120 has an average thickness greater than about 750, 1000, 1500, or 2000 nm, for example. The average thickness of the absorbing polarizer layer 120 can be up to about 30 micrometer or up to about 20 micrometers, for example. In some embodiments, each of the first and second polymeric layers has an average thickness of less than about 500 and the first protective layer has an average thickness greater than about 750 nm, for example. In some embodiments, the bonding layer 26 has an average thickness in a range of about 0.5 to 20 microns, or about 1 to 10 microns, or about 1.5 to 8 microns. In some embodiments, the bonding layer 26 has an average thickness greater than the average thickness of each of the first and second polymeric layers. In some embodiments, the bonding layer 26 has an average thickness greater than the average thickness of the first protective layer 24. In some embodiments, the olefin layer 28 has an average thickness in any of the ranges described for the bonding layer 26 or the protective layers.

In some embodiments, the plurality of alternating first and second polymeric layers number at least 10, 20, 50, 75, 100, 150, 200, 250, 300, 350, or 400 in total. The plurality of alternating first and second polymeric layers may number, for example, up to 1500 or 1000 in total. For example, the plurality of alternating first and second polymeric layers 21, 22 may number from 10 to 1500 or from 20 to 1000 in total in total.

The optical film 150 can include additional layers. For example, the optical film can include a second protective layer 24′ disposed on the plurality of alternating layers 21, 22 opposite the first protective layer 24. The optical film may further include one or more additional layers 25 disposed between sub-pluralities of the plurality of alternating layers 21, 22, as schematically illustrated in FIG. 4. The one or more additional layers 25 (and the layers 24, 24, 24″, 24′″) may be protective boundary layers as would be appreciated by those of ordinary skill in the art. At least one of the layers 25, 24, 24′, 24″, 24′″ can be an absorbing polarizer layer. Each of the one or more additional layers 25, and/or the protective layers 24, 24″, 24′″ can have an average thickness in any range described for the first protective layer 24.

In some embodiments, the bonding layer 26 includes a plurality of sublayers. For example, the bonding layer 26 can include a sublayer 26a for bonding to the olefin layer 28 and a sublayer 26b for bonding to the first protective layer 24 as schematically illustrated in FIG. 4. The plurality of sublayers may include only 2 sublayers or may include more than 2 sublayers. In some embodiments, the bonding layer 26 is a single monolithic layer which may directly contact the olefin layer 28 and the polarizer 100.

In some embodiments, the olefin layer 28 has an unstructured major surface 281 opposite the polarizer 100. An unstructured major surface is generally free of structures (e.g., microstructures) generated in the surface for any optical or mechanical purpose, for example, but may include marks or other features resulting from ordinary manufacturing processes. The unstructured major surface can be characterized in terms a surface roughness (e.g., average peak-to-valley surface roughness commonly denoted Rz) and/or in terms of a haze. In some embodiments, the unstructured major surface 281 has an average peak-to-valley surface roughness Rz of less than about 2, 1.5, 1, 0.5, 0.4, 0.3, 0.2, or 0.1 micrometers. Rz can be as low as about 70, 60, 50, 40, 30, or 20 nm, for example. In some embodiments, the optical film 150 has a transmitted haze of less than about 5, 4.5, 4, 3.5, 3, 2.5, 2, 1.5, or 1 percent. Transmitted haze can be determined according to the ASTM D1003-13 test standard, for example.

The protective layer(s) may have a same composition as one of the first and second polymeric layers. Suitable materials for the various layers include, for example, polyethylene naphthalate (PEN), coPEN (copolyethylene naphthalate terephthalate copolymer), polyethylene terephthalate (PET), polyhexylethylene naphthalate copolymer (PHEN), syndiotactic polystyrene (sPS), glycol-modified PET (PETG), glycol-modified PEN (PENG), coPET-polycarbonate alloys, various other copolyesters such as those described elsewhere herein, polyolefins, polymethyl methacrylate (PMMA), coPMMA (a copolymer of methyl methacrylate and ethyl acrylate), other acrylics, or blends thereof. Other suitable materials for the various layers include those described in U.S. Pat. No. 5,103,337 (Schrenk et al.): U.S. Pat. No. 5,540,978 (Schrenk): U.S. Pat. No. 5,882,774 (Jonza et al.): U.S. Pat. No. 6,179,948 (Merrill et al.): U.S. Pat. No. 6,207,260 (Wheatley et al.): U.S. Pat. No. 6,783,349 (Neavin et al.): U.S. Pat. No. 6,967,778 (Wheatley et al.): U.S. Pat. No. 9,069,136 (Weber et al.); and U.S. Pat. No. 9,162,406 (Neavin et al.), for example.

In some embodiments, at least one of the first and second polymeric layers comprises a polymer comprising naphthalate groups (e.g., PEN or coPEN). In some embodiments, at least one of the first and second polymeric layers comprises a polymer comprising terephthalate groups (e.g., PET or coPET). In some embodiments, the first polymeric layers are birefringent, and the second polymeric layers are substantially optically isotropic. The birefringent layers can comprise a polymer comprising naphthalate groups and/or terephthalate groups. The substantially isotropic layers can comprise a polyester, copolyester, or a polycarbonate/copolyester alloy, for example. In addition, or alternatively, the protective layer(s) can be formed from any of these materials. Such materials have been found to bond well to the bonding layers described elsewhere herein that can bond well to an olefin layer.

The absorbing polarizer layer can be or include a polymeric layer including oriented dye molecules 121 dispersed therein. The dye molecules 121 can be dichroic dyes such as those available from Mitsui Fine Chemical (Japan). Example dichroic dyes available from Mitsui Fine Chemical include PD-325H, PD-335H, PD-104, and PD-318H. The oriented dye molecules 121 can be dispersed substantially uniformly in a polymer of the polymeric layer. The polymer can be any of the polymers described for the alternating first and second layers and the protective layers. In some embodiments, the polymer is birefringent (e.g., the polarizer layer can be stretched to orient dye molecules and polymer molecules in the stretch direction). In some embodiments, the polymer is substantially optically isotropic (e.g., the polarizer layer can be stretched to orient dye molecules but heated to a sufficiently high temperature that the polymer does not retain birefringence). In some embodiments, the polymer is PEN, coPEN, PET, or coPET. In some embodiments, the polarizer 100 includes at least one protective layer disposed on the absorbing polarizer layer. The protective layer(s) can be polycarbonate/copolyester alloy layers, for example. In some embodiments, the polarizer 100 includes a PEN or coPEN layer disposed between polycarbonate/copolyester alloy layers where the PEN or coPEN layer includes dichroic dye dispersed therein.

Any of the birefringent layers can have a maximum birefringence (e.g., absolute value of refractive index difference in x- and z-directions) at a first wavelength (e.g., 532 nm, 550 nm, or 633 nm) in a wavelength range of about 400 nm to about 700 nm of greater than about 0.05, 0.08, 0.1, 0.12, or 0.15, for example. Any of the substantially isotropic layers can have a maximum birefringence at the first wavelength of less than about 0.025, 0.02, 0.015, 0.01, or 0.005, for example. The birefringent layers can have a refractive index along at least one direction greater than a refractive index of the substantially isotropic layers by at least about 0.05, 0.08, 0.1, 0.12, or 0.15, for example, for at least the first wavelength. The maximum difference in refractive indices between different layers along a same direction or between different directions in a same layer may be up to about 0.5, 0.4, or 0.3, for example, at the first wavelength. For optically absorptive layers, the refractive index refers to the real part of the complex refractive index, unless indicated differently.

In some embodiments, the bonding layer 26 has a glass transition temperature (Tg) less than about −100° C. or less than about −120° C. In some such embodiments, or in other embodiments, the bonding layer has a melting point greater than about 80° C., or greater than about 100° C., or greater than about 120° C. For example, the bonding layer 26 can have a glass transition temperature less than about −100° C. and a melting point greater than about 80° C. or greater than about 100° C. As another example, the bonding layer 26 can have a glass transition temperature less than about −120° C. and a melting point greater than about 100° C. or greater than about 120° C. In some embodiments, the olefin layer 28 has a glass transition temperature in a range of 100° C. to 115° C. or 105° C. to 110° C. Having the Tg of the olefin layer 28 in these range helps with the processability of the film. For example, with some processing methods, too low a Tg and the film can stick to the tentor clips, while too high Tg can result in the film not orienting as desired and developing the desired optics. The glass transition temperature can be determined by differential scanning calorimetry according to the ASTM E1356-08 (Reapproved 2014) standard, for example.

In some embodiments, the bonding layer 26 (and/or other layers of the optical film 150, 150′) has a weight-averaged molecular weight greater than about 20,000, 30,000, 40,000 or 50,000 Daltons or in a range described elsewhere herein. In some embodiments, a composition of the bonding layer 26 is different from compositions of each of the first protective layer 24 and the first and second polymeric layers 21 and 22. The bonding layer 26 can be or include an ethylene copolymer. The ethylene copolymer can include one or more of a styrenic group, an acrylic group, a vinyl group, or a maleic anhydride group, for example. Suitable ethylene copolymers include those available from KRATON Corporation (Huston, TX) under the KRATON tradename and those available from Dow Chemical (Midland, MI) under the BYNEL and ELVALOY tradenames, for example. The bonding layer 26 may be or include a PETG layer, for example. Suitable PETG includes GN071 available from Eastman Chemical (Kingsport, TN), for example.

In some embodiments, the optical film 150, 150′ includes an ethylene copolymer layer 26 disposed on the first protective layer 24 opposite the plurality 20 of alternating first and second polymeric layers 21 and 22. In some embodiments, the optical film 150 further includes an olefin layer 28, where the ethylene copolymer layer 26 bonds the olefin and first protective layers to one another. The ethylene copolymer layer 26 can include an ethylene copolymer as described further elsewhere herein.

The olefin layer 28 can comprises cyclic olefin copolymer (COC), cyclic olefin polymer (COP), or a blend thereof, for example. Suitable olefin polymers and copolymers for the olefin layer 28, and/or for the lens substrate 220 (see, e.g., FIG. 3), include those available from TOPAS Advanced Polymers GmbH (Raunheim, Germany) under the TOPAS tradename and those available from Zeon Specialty Materials, Inc. (San Jose, CA) under the ZEONOR tradename, for example.

The materials of the various layers can be selected to provide a high delamination force. In some embodiments, the optical film has an average delamination force of greater than about 100, 200, 300, 500, 1000, 1500, 2000, 3000, 4000, 4500, or 5000 g/in. In some embodiments, the delamination force is so high that the layers of a 1 inch wide strip of the film cannot be delaminated using a 10 pound load cell. The delamination force is determined using a 90 degree peel with a pull speed of 12 inches per minute, unless indicated differently. In some embodiments, an optical film having an average delamination force in any of these ranges is formed from a plurality of alternating first and second polymeric layers disposed on a first protective layer with a bonding layer disposed on the first protective layer opposite the plurality of alternating first and second polymeric layers, where each of the first polymeric layers comprises a polymer comprising naphthalate groups and/or terephthalate groups: each of the first protective layer and the second polymeric layers comprises a polyester, copolyester, or polycarbonate/copolyester alloy; and the bonding layer comprises an ethylene copolymer. The polyester, copolyester, or polycarbonate/copolyester alloy of the first protective layer may have the same or different composition as the polyester, copolyester, or polycarbonate/copolyester alloy of the second polymeric layers. The ethylene copolymer can include one or more of a styrenic group, an acrylic group, a vinyl group, or a maleic anhydride group.

In some embodiments, each layer of the optical film 150 is formed from a thermoplastic polymer. The thermoplastic polymers can be selected to be readily extrudable and processable. For example, the thermoplastic polymers can be selected to have molecular weights and/or intrinsic viscosities and/or melt flow indices (MFIs) in suitable ranges for extrudability. In some embodiments, each of the thermoplastic polymers has a weight-averaged molecular weight Mw greater than 20,000 Daltons, or greater than 30,000 Daltons, or greater than 40,000 Daltons, or greater than 50,000 Daltons. The weight-averaged molecular weight Mw can be up to 1,000,000 Daltons, or up to 600,000 Daltons or up to 400,000 Daltons, or up to 200,000 Daltons or up to 150,000 Daltons, for example. In some such embodiments, or in other embodiments, each of the thermoplastic polymers has an intrinsic viscosity in range of 0.3 dl/g to 1.2 dl/g or 0.4 dl/g to 1.0 dl/g when measured in a solvent blend comprising 60 weight percent o-chlorobenzene and 40 weight percent phenol. In some such embodiments, or in other embodiments, the thermoplastic polymers have a melt flow index greater than 5 g/10 min, or greater than 10 g/10 min, or greater than 20 g/10 min. The melt flow index may be up to 300 g/10 min, or up to 200 g/10 min, or up to 100 g/10 min, for example. The weight averaged molecular weight Mw can be determined using gel permeation chromatography, for example. The intrinsic viscosity can be determined using a capillary viscometer, for example. The melt flow index, which may alternatively be referred to as melt flow rate, can be determined using an extrusion plastometer according to ASTM D1238-20, for example.

In embodiments where the optical film 150 include bonding, olefin and absorbing polarizer layers: the bonding, olefin and absorbing polarizer layers can be coextruded and co-stretched with one another. The optical film is generally stretched after extrusion in order to orient the polymer of the polarizing layer(s) and/or dye molecules in the polarizing layer(s). In embodiments where the optical film 150 further includes a plurality 20 of alternating first and second polymeric layers: the plurality of alternating first and second polymeric layers can be coextruded and co-stretched with the olefin, bonding and absorbing polarizer layers. In embodiments where the optical film 150 includes a bonding layer 26, an olefin layer 28, an absorbing polarizer layer 120 and a reflective polarizer 20, the absorbing polarizer layer: the reflective polarizer, or both (100 and 20) can be coextruded and co-stretched with the bonding and olefin layers. In embodiments where the optical film 150 includes ethylene copolymer, olefin and absorbing polarizer layers: the ethylene copolymer, olefin and absorbing polarizer layers can be coextruded and co-stretched with one another. In embodiments, where the polarizer further comprises a plurality 20 of alternating first and second polymeric layers: the plurality of alternating first and second polymeric layers can be coextruded and co-stretched with the olefin, ethylene copolymer and absorbing polarizer layers. In embodiments where the optical film 150 includes an ethylene copolymer layer 26, an absorbing polarizer layer 120, and a plurality 20 of alternating first and second polymeric layers: the absorbing polarizer layer, the plurality of alternating first and second polymeric layers, or both (120 and 20) can be coextruded and co-stretched with the ethylene copolymer layer.

The optical film 150 can be integrally formed. As used herein, a first element “integrally formed” with a second element means that the first and second elements are manufactured together rather than manufactured separately and then subsequently joined. Integrally formed includes manufacturing a first element followed by manufacturing the second element on the first element. An optical film including a plurality of layers is integrally formed if all of the layers are manufactured together (e.g., combined as melt streams and then cast onto a chill roll to form a cast film having each of the layers, and then orienting the cast film) rather than manufactured separately and then subsequently joined. In some embodiments, all layers of the optical film 150, are coextruded. In some embodiments, all layers of the optical film 150 are further co-stretched.

As is known in the art, multilayer optical films including alternating polymeric layers can be used to provide desired reflection and transmission in desired wavelength ranges by suitable selection of layer thicknesses and refractive index differences. Multilayer optical films and methods of making multilayer optical films are described in U.S. Pat. No. 5,882,774 (Jonza et al.): U.S. Pat. No. 6,783,349 (Neavin et al.): U.S. Pat. No. 6,949,212 (Merrill et al.): U.S. Pat. No. 6,967,778 (Wheatley et al.); and U.S. Pat. No. 9,162,406 (Neavin et al.), for example.

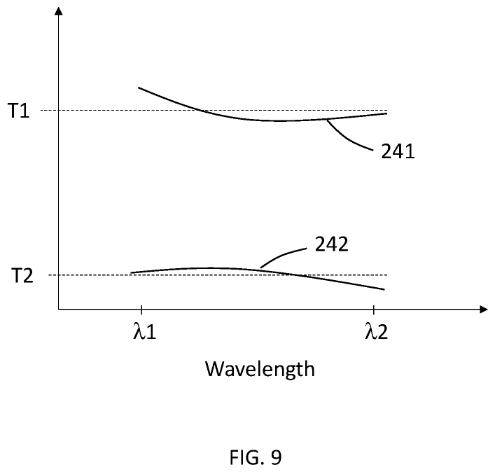

FIG. 9 is a schematic plot of transmission 241 and 242 versus wavelength for light substantially normally incident on a polarizer for orthogonal first and second polarization states 141 and 142 (see, e.g., FIG. 1), according to some embodiments. The polarizer of FIG. 9 can be an absorbing polarizer layer (e.g., layer 120), a reflective polarizer (e.g., corresponding to the plurality 20 of alternating layers with any protective boundary layers), a plurality (e.g., plurality 20) of alternating first and second polymeric layers, or the polarizer 100. The polarizer has average optical transmittances T1 and T2 for the respective first and second polarization states 141 and 142 for a wavelength range of Al (e.g., 400 nm, 420 nm, or 450 nm) to Al (e.g., 7000 nm, 680 nm, or 650 nm). The shape of the transmission curves can be different from those schematically shown in FIG. 9 as would be appreciated by those of ordinary skill in the art. In some embodiments, for orthogonal first and second polarization states 141 and 142, and for at least one wavelength (e.g., 532 nm, 560 nm, and/or 633 nm) in a wavelength range of about 420 nm to about 680 nm, the polarizer 100 substantially transmits the incident light having the first, but not the second, polarization state. In some embodiments, for substantially normally incident (e.g., angle of incidence less than about 30, 20, 10, or 5 degrees) light 140 (see, e.g., FIG. 1), for orthogonal first and second polarization states 141 and 142, and for at least one wavelength in a wavelength range of about 420 nm to about 680 nm, the polarizer 100 substantially transmits the incident light having the first, but not the second, polarization state. Substantially transmits means that greater than 50 percent of the light is transmitted. In some embodiments, for the at least one wavelength, the polarizer transmits greater than 50, 60, 70, 80, or 85 percent of the incident light having the first polarization state 141. In some embodiments, for the at least one wavelength, the polarizer 100 transmits less than 50, 40, 30, 20, or 10 percent of the incident light having the first polarization state 141. In some embodiments, for substantially normally incident light 140 and for a predetermined wavelength range (e.g., 400 nm to 700 nm, or 420 nm to 680 nm, or 450 nm to 650 nm), the polarizer 100, the absorbing polarizer layer 120, the reflective polarizer, the plurality 20 of alternating layers, each of the absorbing polarizer layer 120 and the reflective polarizer, or each of the absorbing polarizer layer 120 and plurality 20 of alternating layers has an average optical transmittance T1 of greater than 50 percent for a first polarization state 141 and an average optical transmittance of less than 50 percent for the second polarization state 142. The average optical transmittance T1 for the first polarization state 141 can be greater than 50, 60, 70, 80, or 85 percent, for example. The average optical transmittance T2 for the second polarization state 142 can be less than 50, 40, 30, 20, or 10 percent, for example.

In some embodiments, the optical film 150 is an absorbing polarizer. In some embodiments, the optical film 150 is a hybrid reflective-absorbing polarizer. The difference between 100% and T1 or T2 is the percent of the incident light reflected and absorbed by the polarizer. In some embodiments, the absorbing polarizer layer 120 absorbs at least 10, 20, 30, 40, 50, 60, 70, 80, 85, or 90 percent of the incident light for the at least one wavelength and the second polarization state 142. In some embodiments, the absorbing polarizer layer 120 has a dichroic ratio of at least about 5, 10, 15, or 20. Dichroic ratio may generally be understood to be the ratio of the absorption constant for the block polarization state 142 to the absorption constant in the pass polarization state 141 and can be determined for at least one wavelength in a wavelength range of about 420 nm to about 680 nm or can be determined as an average dichroic ratio over the wavelength range of about 420 nm to about 680 nm.

In embodiments where a reflective polarizer and an absorbing polarizer layer are coextruded and co-stretched with one another, the pass axis (e.g., y-axis, or axis along polarization state 141, or axis with highest transmission of normally incident light polarized along the axis) and block axis (e.g., x-axis, or axis along polarization state 142, or axis with lowest transmission of normally incident light polarized along the axis) or the reflective polarizer are generally well aligned (e.g., to within about 5, 4, 3, 2, or 1 degrees) with corresponding pass and block axes of the absorbing polarizer. In embodiments where a reflective polarizer and an absorbing polarizer layer are formed separately and bonded to one another, it is generally desired that the respective pass and block axes be suitably aligned (e.g., within about 15, 12, 10, 8, 5, 4, 3, 2, or 1 degrees). For example, the absorbing polarizer layer can have a first block axis, the reflective polarizer can have a second block axis, where the first and second block axes can be substantially parallel to one another and/or parallel to within about 15, 12, 10, 8, 5, 4, 3, 2, or 1 degrees.

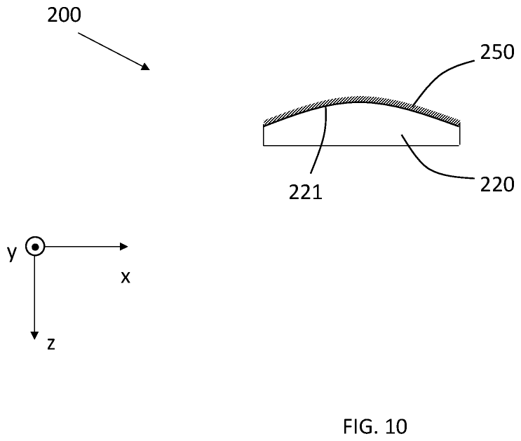

FIG. 10 is a schematic cross-sectional view of an optical lens 200, according to some embodiments. The optical lens 200 includes a lens substrate 220 and any optical film 250 (e.g., corresponding to optical film 150) of the present description disposed on, and substantially conforming to, a major surface 221 of the lens substrate 220. The optical film 250 can substantially conform to the major surface when the optical film conforms to the major surface up to ordinary manufacturing variations when the lens is (e.g., injection) molded onto the optical film. The olefin layer 28 and/or the ethylene copolymer layer can face the lens substrate 220 (see, e.g., the x-y-z coordinate systems schematically illustrated in FIGS. 1-8). In some embodiments, the lens substrate 220 comprises an olefin composition. The olefin composition can be or include cyclic olefin polymer (COP), cyclic olefin copolymer (COP), or a blend thereof. In some such embodiments, or in other embodiments, the olefin layer 28 bonds the optical film 250 to the lens substrate 220.

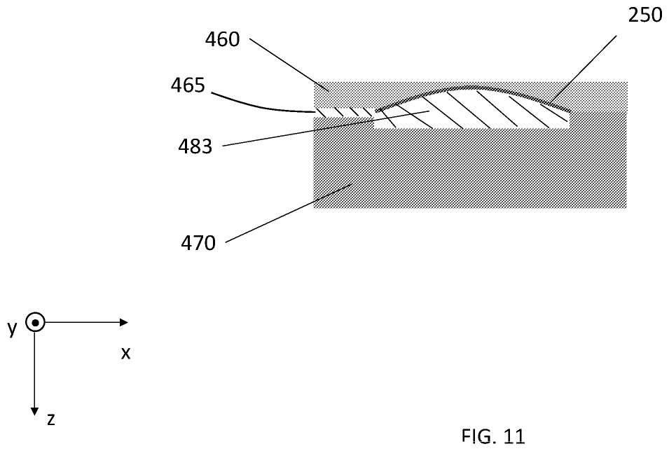

FIG. 11 is a schematic illustration of a method of making an optical lens, according to some embodiments. The method includes providing an optical film 250 which can be as described elsewhere herein for optical film 150. For example, the optical film 250 can include a polarizer 100 including an absorbing polarizer layer 120: an olefin layer 28 disposed on the polarizer 100; and a bonding layer 26 disposed between, and bonding together, the olefin layer 28 and the polarizer 100. The method includes molding a lens substrate 220 onto the optical film 250 such that the lens substrate faces 220 and bonds to the olefin layer 28. The lens substrate can comprise an olefin composition. The olefin layer can comprise cyclic olefin copolymer, cyclic olefin polymer, or a blend thereof. In some embodiments, providing the optical film includes coextruding and co-stretching the olefin layer, the bonding layer and at least one layer of the polarizer. In some embodiments, the at least one layer of the polarizer includes the absorbing polarizer layer. In some embodiments, the polarizer includes a plurality of alternating first and second polymeric layers numbering at least 10 in total where each of the first and second polymeric layers has an average thickness less than about 500 nm. In some such embodiments, the at least one layer of the polarizer includes the plurality of alternating first and second polymeric layers. Providing the optical film 250 can include coextruding and co-stretching all layers of the optical film. Molding the lens substrate 220 onto the optical film 250 can include an insert molding process where, in brief summary, the optical film 250 is placed adjacent a surface of an upper mold portion 460 and resin 483 (e.g., a molten olefin composition) is injected into a cavity (e.g., through gate 465) between the optical film 250 and a bottom mold portion 470. Suitable insert molding processes are known in the art. Further details on suitable insert molding processes can be found, for example, in U.S. Pat. Appl. Pub. No. 2021/0208320 (Ambur et al.) and in U.S. Pat. No. 11,065,855 (Klun et al.).

### EXAMPLES

All parts and percentages in the Examples are by weight unless indicated otherwise. Reagents and solvents are available from MILLIPORE-SIGMA (Burlington, MA), except wherein indicated otherwise.

| Material | Description |
|---|---|
| TOPAS 8007F | Cyclic olefin copolymer (COC) available from Advanced |
| | Polymers GmbH (Raunheim, Germany) |
| TOPAS 8007S | COC available from Advanced Polymers GmbH (Raunheim, |
| | Germany) |
| TOPAS 6013S | COC available from Advanced Polymers GmbH (Raunheim, |
| | Germany) |
| TOPAS E140 | COC elastomer available from Advanced Polymers GmbH |
| | (Raunheim, Germany) |
| ZEONOR 1420r | Cyclic olefin polymer (COP) available from Zeon Specialty |
| | Materials, Inc. (San Jose, CA) |
| KRATON 1645 | Styrene-ethylene-butylene-styrene (SEBS) available from |
| | KRATON Corporation (Huston, TX) |
| ELVALOY 1125AC | Ethylene methyl acrylate (EMA) available from Dow |
| | Chemical (Midland, MI) |
| BYNEL 22E780 | Ethylene copolymer available from Dow Chemical (Midland, |
| | MI) |
| ELVALOY 2618 | Ethylene methyl acrylate (EMA) available from Dow |
| | Chemical (Midland, MI) |
| BYNEL 3101 | Ethylene vinyl acrylate (EVA) available from Dow Chemical |
| | (Midland, MI) |
| LMPEN | Low-melt PEN (coPEN with 90 percent naphthalate groups) |
| PEN | Polyethylene naphthalate (PEN) |
| LMPEN | Low-melt PEN (coPEN with 90 percent naphthalate groups) |
| PET | PET having an intrinsic viscosity of 0.62 |
| GN071 | Glycol-modified PET (PETG) available from Eastman |
| | Chemical (Kingsport, TN) |

Two sets of films having the layer structure ABCBA were made via coextrusion followed by co-stretching for some film samples. The films showed that coextrudable/co-strechable materials can be chosen for B layers when the A layers were formed from an olefin and the C layer was formed from a polyester commonly used in multilayer optical films. Films including absorbing polarizer layer(s), and/or having the structure ABC′DCDCDC . . . , for example, where C′ is a protective layer (e.g., a protective boundary layer) and the alternating D and C layers are adapted to reflect light primarily by optical inference, for example, and/or where the D or C layers include absorbing polarizing dyes, can be made similarly.

The first set of films having an ABCBA structure were made via the following procedure. The outer (A) layers were produced by extruding resin through a 27 mm TSE (twin-screw extruder) through a neck tube and gear pump into a 5 layer feed block and die. This melt train used a progressive temperature extrusion profile, with peak temperatures of 270° C. The bonding (B) layer was produced by extruding resin through a 27 mm TSE with a progressive temperature profile peaking at or around 260° C. through a neck tube and gear pump into a 5 layer feed block. The core (C) layer was produced by extruding the above identified resin through a 27 mm TSE with a progressive temperature profile peaking at or around 270° C. through a neck tube and gear pump into a 5 layer feed block. The feedblock/die was held at a target temp of 270° C. while the casting wheel was run between 50° C. and 70° C. The film materials were as indicated in the following table. Feed rates for each of the TSEs was 10 lbs/hr except for the C layer of Sample 10 where a 14.4 lbs/hr feed rate was used. Parts by weight are indicated in parentheses for blends.

| | | B Layer | C Layer |
|---|---|---|---|
| Film No. | A Layer Resin | Resin | Resin |
| 1 | ZEONOR | GN071 | LMPEN |
| | 1420r | | |
| 2 | ZEONOR | GN071 | LMPEN |
| | 1420r/ | | |
| | TOPAS 8007F | | |
| | (70/30) | | |
| 3 | ZEONOR | KRATON | LMPEN |
| | 1420r/ | 1645 | |
| | TOPAS 8007F | | |
| | (70/30) | | |
| 4 | ZEONOR | BYNEL | LMPEN |
| | 1420r/ | 22E780 | |
| | TOPAS 8007F | | |
| | (70/30) | | |
| 5 | ZEONOR | ELVALOY | LMPEN |
| | 1420r/ | 2618 | |
| | TOPAS 8007F | | |
| | (70/30) | | |
| 6 | ZEONOR | BYNEL | LMPEN |
| | 1420r/ | 3101 | |
| | TOPAS 8007F | | |
| | (70/30) | | |
| 7 | ZEONOR | KRATON | LMPEN |
| | 1420r/ | 1645 | |
| | TOPAS 8007F | | |
| | (80/20) | | |
| 8 | TOPAS | KRATON | LMPEN |
| | 8007F | 1645 | |
| 9 | TOPAS | KRATON | LMPEN/ |
| | 8007F | 1645 | PET (7.5/2.5) |
| 10 | TOPAS | KRATON | LMPEN/ |
| | 8007F | 1645 | PET (7.5/2.5) |
| 11 | TOPAS | KRATON | LMPEN/ |
| | 8007F | 1645 | PET |
| | | | (11.25/3.15) |
| 12 | TOPAS | KRATON | PET |
| | 8007F | 1645 | |

Various film samples were oriented and annealed in a two stage KARO IV lab stretching device (available from Bruckner Maschinenbau Siegsdorf, Germany) using the following procedure: Cast web films were conveyed into the oven at various temperatures as indicated in the tabled below and held for 60 seconds and then stretched at several different ratios as indicated in the tables below (the oriented area of the film is x by X longer in each direction than the initial film when the draw ratio is given as x by X). The film was then removed from the KARO and evaluated. Transmitted haze was measured using a haze-gard i haze meter available from BYK Instruments.

The transmitted haze (in percent) for film samples stretched at a 1×5 draw ratio are reported in the following table.

| | 1 × 5 | | | | |
|---|---|---|---|---|---|
| Film No. | 130° C. | 135° C. | 140° C. | 145° C. | 150° C. |
| 9 | | 2.91 | | | |
| 10 | 2.68 | 4.04 | 0.55 | 1.01 | 0.83 |
| 11 | 3.17 | 4.27 | | | |

The transmitted haze (in percent) for film samples stretched at a 1×5.5 draw ratio are reported in the following table.

| | 1 × 5.5 | | | | |
|---|---|---|---|---|---|
| | 130° C. | 135° C. | 140° C. | 145° C. | 150° C. |
| 9 | | 2.81 | | | |
| 10 | 2.46 | 2.02 | 0.75 | 1 | 0.87 |
| 11 | 1.96 | 4.76 | | | |

The transmitted haze (in percent) for film samples stretched at a 1×6 draw ratio are reported in the following table.

| | 1 × 6 | | | | |
|---|---|---|---|---|---|
| | 130° C. | 135° C. | 140° C. | 145° C. | 150° C. |
| 9 | | 2.99 | | | |
| 10 | 2.5 | 2.23 | 1.73 | 1.23 | 0.74 |
| 11 | 2.74 | 3.81 | | | |

The transmitted haze (in percent) for film samples stretched at the indicated draw ratios and annealed at 215° C. for 15 seconds are reported in the following table.

| | 1 × 5 | | 1 × 5.5 | | 1 × 6 | |
|---|---|---|---|---|---|---|
| | 130° C. | 135° C. | 130° C. | 135° C. | 130° C. | 135° C. |
| 10 | 0.52 | 0.24 | 0.49 | 0.33 | 0.48 | 0.61 |
| 11 | 0.37 | 0.34 | 0.35 | 0.33 | 0.4 | 0.37 |

The transmitted haze (in percent) for a film sample that had not been annealed and for a corresponding sample that was annealed at 215° C. for 15 seconds are reported in the following table.

1 × 5

| | | 105° C. |
|---|---|---|
| | | Annealed |
| | 105° C. | at 215° C. |
| 12 | 4.35 | 1.05 |

The transmitted haze (in percent) for film samples biaxially stretched at the indicated draw ratios are reported in the following table.

135° C.

| | 3 × 3 | 3.5 × 3.5 |
|---|---|---|
| 10 | 4.28 | 4.79 |
| 11 | 2.7 | 4.17 |

The transmitted haze (in percent) for film samples biaxially stretched at the indicated draw ratios and annealed at 215° C. for 15 seconds are reported in the following table.

135° C.

| | 3 × 3 | 3.5 × 3.5 |
|---|---|---|
| 10 | 1.05 | 0.5 |
| 11 | 0.36 | 0.42 |

The second set of films having an ABCBA structure were made to determine effects the A layer composition (e.g., effect of the glass transition temperature of COC blends) on optical and bonding properties, for example. Film samples were made as generally described above with the resins indicated in the table below. The feed rate for each of the TSEs was 10 lbs/hr for each sample.

| | | B Layer | C Layer |
|---|---|---|---|
| Description | A Layer Resin | Resin | Resin |
| 13 | TOPAS 8007F | GN071 | PEN |
| 14 | TOPAS 8007F | KRATON | PEN |
| | | 1645 | |
| 15 | TOPAS 8007F/ | KRATON | PEN |
| | TOPAS | 1645 | |
| | 6013S (40/60) | | |
| 16 | TOPAS 8007F/ | KRATON | PEN |
| | TOPAS | 1645 | |
| | 6013S (30/70) | | |
| 17 | TOPAS 8007F/ | KRATON | PEN |
| | TOPAS | 1645 | |
| | 6013S (20/80) | | |
| 18 | TOPAS 8007F/ | KRATON | PEN |
| | TOPAS | 1645 | |
| | E140 (95/05) | | |
| 19 | TOPAS 8007F/ | KRATON | PEN |
| | TOPAS | 1645 | |
| | E140 (80/20) | | |
| 20 | TOPAS 8007F/ | KRATON | PEN |
| | TOPAS | 1645 | |
| | E140 (60/40) | | |

The glass transition temperatures (Tg) of the A layers were obtained using a Differential Scanning calorimeter (DSC). The DSC used a heat/cool/heat cycle. Each sample was weighed and placed in a DSC. The following Method was used. Method Log:
1: Data storage: Off
2: Equilibrate at −70.00° C.
3: Isothermal for 5.00 min
4: Data storage: On
5: Ramp 20.00° C./min to 200.00° C.
6: Mark end of cycle 1
7: Data storage: Off
8: Equilibrate at 200.00° C.
9: Isothermal for 5.00 min
10: Data storage: On
11: Ramp 20.00° C./min to −70.00° C.
12: Mark end of cycle 2
13: Data storage: Off
14: Equilibrate at −70.00° C.
15: Modulate +/−1.00° C. every 60 seconds
16: Isothermal for 5.00 min
17: Data storage: On
18: Ramp 3.00° C./min to 200.00° C.
19: Mark end of cycle 3
20: Data storage: Off
21: End of method

The Tg was then measured at the inflection point of the hump during the second ramp cycle starting at step 18, which one skilled in the art would recognize as the Tg. The resulting Tgs are reported in the following table.

| Film No. | Resin Blend | Tg (° C.) |
|---|---|---|
| 15 | TOPAS 8007F/TOPAS | 112 |
| | 6013S (40/60) | |
| 16 | TOPAS 8007F/TOPAS | 117 |
| | 6013S (30/70) | |
| 17 | TOPAS 8007F/TOPAS | 122 |
| | 6013S (20/80) | |
| NA | TOPAS 8007F | 78 |
| NA | TOPAS 6013S | 138 |

Film samples were uniaxially oriented in the two stage KARO lab stretching device using the following procedure: Cast web films were conveyed into the oven at various temperatures and held for 60 seconds and then stretched at several different ratios. The film was then removed from the KARO and evaluated for haze as described above. The resulting transmitted haze in percent for various draw ratios and oven temperatures are indicated in the tables below.

| | 140° C. | | | 145° C. | | |
|---|---|---|---|---|---|---|
| Film No. | 1 × 5 | 1 × 5.5 | 1 × 6 | 1 × 5 | 1 × 5.5 | 1 × 6 |
| 15 | 2.42 | 2.69 | 2.6 | 1.73 | 1.97 | 3.39 |
| 16 | 1.92 | | 0.41 | 2.57 | 2.64 | 2.42 |
| 17 | 68.7 | | | 2.01 | 2.01 | 1.86 |
| 19 | | | 1.48 | | | |
| 20 | | | 40.1 | | | |

| | 150° C. | | |
|---|---|---|---|
| Film No. | 1 × 5 | 1 × 5.5 | 1 × 6 |
| 16 | 3.28 | 3.14 | 3.36 |
| 17 | 2.71 | 2.36 | 2.26 |

Delamination force was then measured for various cast film samples using an IMASS SP-2100 with a 10 lb load cell. The film was cut into 1″ wide samples and laminated to glass with double sided tape. The glass was loaded into the IMASS holder to measure a 90-degree peel. The pull speed was set to 12″/min, with a 2 second delay, and the force was averaged for 5 seconds. This was repeated 4 times. The average was taken and reported. The table below reports the delamination (peel) force data for these films. Many films showed undelamable peel force, or delamination force high enough separation of the film stack would not occur in end use applications.

| | Peel Force |
|---|---|
| Film No. | (g/in) |
| 1 | 5 |
| 2 | 10 |
| 3 | 1679 |
| 4 | Undelamable |
| 5 | Undelamable |
| 6 | Undelamable |
| 7 | Undelamable |
| 9 | 2301 |
| 10 | 2273 |
| 13 | 291 |
| 14 | Undelamable |
| 15 | Undelamable |
| 16 | Undelamable |
| 17 | Undelamable |
| 18 | Undelamable |
| 19 | Undelamable |
| 20 | Undelamable |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical film comprising:
a polarizer comprising an absorbing polarizer layer, wherein for substantially normally incident light, for orthogonal first and second polarization states, and for at least one wavelength in a wavelength range of about 420 nm to about 680 nm, the polarizer substantially transmits the incident light having the first, but not the second, polarization state;
an olefin layer disposed on the polarizer, the olefin layer comprising cyclic olefin copolymer, cyclic olefin polymer, or a blend thereof, and
a bonding layer disposed between, and bonding together, the olefin layer and the polarizer, the bonding layer comprising ethylene copolymer,
wherein the bonding, olefin and absorbing polarizer layers are coextruded and co-stretched with one another.

17. The optical film of claim 16, wherein the olefin layer has an unstructured major surface opposite the polarizer.

18. The optical film of claim 17, wherein the unstructured major surface has an average peak-to-valley surface roughness Rz of less than about 1 micrometer.

19. The optical film of claim 16, wherein the polarizer further comprises a plurality of alternating first and second polymeric layers disposed on the absorbing polarizer layer, each of the first and second polymeric layers having an average thickness less than about 500 nm.

20. The optical film of claim 19, wherein the plurality of alternating first and second polymeric layers is coextruded and co-stretched with the olefin, bonding and absorbing polarizer layers.

21. The optical film of claim 16, wherein the absorbing polarizer layer comprises a polymeric layer comprising oriented dye molecules dispersed therein.

22. The optical film of claim 16 having a transmitted haze of less than about 5 percent.

23. The optical film of claim 16, wherein the bonding layer has a glass transition temperature less than about −100° C. and a melting point greater than about 80° C.

24. An optical lens comprising a lens substrate and the optical film of claim 16 disposed on, and substantially conforming to, a major surface of the lens substrate, the olefin layer facing the lens substrate.

25. An optical film comprising:
a polarizer comprising an absorbing polarizer layer disposed on a reflective polarizer, the reflective polarizer comprising a plurality of alternating first and second polymeric layers numbering at least 10 in total, each of the first and second polymeric layers having an average thickness less than about 500 nm;
an olefin layer disposed on the polarizer, the olefin layer comprising cyclic olefin copolymer, cyclic olefin polymer, or a blend thereof, the olefin layer comprising an unstructured major surface opposite the polarizer; and
a bonding layer disposed between, and bonding together, the olefin layer and the polarizer, the bonding layer comprising ethylene copolymer,
wherein the absorbing polarizer layer, the reflective polarizer, or both are coextruded and co-stretched with the bonding and olefin layers.

26. The optical film of claim 25, wherein all layers of the optical film are coextruded and co-stretched with one another.

27. An optical lens comprising a lens substrate and the optical film of claim 25 disposed on, and substantially conforming to, a major surface of the lens substrate, the olefin layer facing the lens substrate.

28. A method of making an optical lens, the method comprising:
providing an optical film comprising:
a polarizer comprising an absorbing polarizer layer, wherein for substantially normally incident light, for orthogonal first and second polarization states, and for at least one wavelength in a wavelength range of about 420 nm to about 680 nm, the polarizer substantially transmits the incident light having the first, but not the second, polarization state;
an olefin layer disposed on the polarizer, the olefin layer comprising cyclic olefin copolymer, cyclic olefin polymer, or a blend thereof; and
a bonding layer disposed between, and bonding together, the olefin layer and the polarizer; and
molding a lens substrate onto the optical film such that the lens substrate faces and bonds to the olefin layer, the lens substrate comprising an olefin composition,
wherein providing the optical film comprises coextruding and co-stretching the olefin layer, the bonding layer and at least one layer of the polarizer.

29. The method of claim 28, wherein the at least one layer of the polarizer comprises the absorbing polarizer layer.

30. The method of claim 28, wherein providing the optical film comprises coextruding and co-stretching all layers of the optical film.

31. The method of claim 28, wherein the bonding layer comprises ethylene copolymer.
